(19) United States
(12) Patent Application Publication
(10) Pub. No.: US 2015/0230121 A1
(43) Pub. Date: Aug. 13, 2015

(54) MTC DEVICE, SERVING NODE, AND VARIOUS METHODS FOR IMPLEMENTING A DOWNLINK STACK REDUCTION FEATURE

(71) Applicant: TELEFONAKTIEBOLAGET L M ERICSSON (PUBL), Stockholm (SE)

(72) Inventors: John Walter DIACHINA, Garner, NC (US); Nicklas JOHANSSON, Brokind (SE); Ravitej BALLAKUR, Bangalore (IN); Paul SCHLIWA-BERTLING, Ljungsbro (SE)

(21) Appl. No.: 14/611,439

(22) Filed: Feb. 2, 2015

Related U.S. Application Data
(60) Provisional application No. 61/937,292, filed on Feb. 7, 2014.

(51) Int. Cl. H04W 28/02

(52) U.S. Cl. CPC H04W 28/0215

(57) ABSTRACT

A machine type communications (MTC) device, a serving node (e.g. SGSN), and various methods are described herein for implementing a downlink stack reduction (DSR) feature. The DSR feature reduces the ratio of UDP/IP overhead to MTC data packet payload in MTC communications which will serve to substantially minimize the amount of radio interface bandwidth consumed and therefore significantly improve the Packet Data Channel (PDCH) utilization within the telecommunication network.

### CLAIM OF PRIORITY

This application claims the benefit of priority to U.S. Provisional Application No. 61/937,292, filed on Feb. 7, 2014. The entire contents of this application are hereby incorporated herein by reference for all purposes.

### RELATED APPLICATION

This application is related to the co-assigned U.S. patent application Ser. No. ______ (Docket No. P42812US2) entitled “MTC Device, Serving Node, and Various Methods for Implementing an Uplink Stack Reduction Feature”. The contents of this document are hereby incorporated herein by reference for all purposes.

### TECHNICAL FIELD

The present disclosure relates to a machine type communications (MTC) device, a serving node (e.g. SGSN), and various methods for implementing a downlink stack reduction (DSR) feature. The DSR feature reduces the ratio of UDP/IP overhead to MTC data packet payload in MTC communications which will serve to substantially minimize the amount of radio interface bandwidth consumed and therefore significantly improve the Packet Data Channel (PDCH) utilization within the telecommunication network.

### BACKGROUND

The following abbreviations are herewith defined, at least some of which are referred to within the following description of the prior art and the present invention.
3GPP Third Generation Partnership Project
ASIC Application-Specific Integrated Circuit
BSS Base Station Subsystem
CRC Cyclic Redundancy Check
DSR Downlink Stack Reduction
EPROM Erasable Programmable Read Only Memory
EEPROM Electrically Erasable Programmable Read-Only Memory
FPGA Field-Programmable Gate Array
GGSN Gateway GPRS Support Node
GPRS General Packet Radio Service
GSM Global System for Mobile Communications
IE Information Element
IP Internet Protocol
LLC Logical Link Control
LTE Long Term Evolution
MS Mobile Station
MTC Machine Type Communications
NAS Non-Access Stratum
N-PDU Network-Packet Data Unit
NSAPI Network Service Access Point Identifier
PCOMP Protocol Control Information Compression Algorithm
PDCH Packet Data Channel
PDU Protocol Data Unit
PS Packet Switched
RAM Random Access Memory
ROM Read Only Memory
SAPI Service Access Point Identifier
SGSN Serving GPRS Support Node
SNDCP Subnetwork Dependent Convergence Protocol
SN-PDU Sub Network-Packet Data Unit
TCP Transmission Control Protocol
UDP User Datagram Protocol
UE User Equipment
UMTS Universal Mobile Telecommunications System
UI User Information
XID eXchange IDentifier

Machine Type Communications (MTC) involve the transmission of MTC data packets which are anticipated to contain a small amount of application payload (e.g. 100 octets) which, when sent to a MTC device, will also typically be sent by the same MTC application server located in an IP network. It is also expected that such MTC data packets will be made within the context of UDP/IP datagrams where UDP adds 6 to 8 octets of overhead (see FIG. 8) to each MTC data packet and IPv6 adds 40 octets of overhead (see FIG. 9) to each MTC data packet. With 46 to 48 octets of UDP/IP overhead per MTC data packet, optimizations that allow for reducing the ratio of UDP/IP overhead to MTC data packet payload will serve to substantially minimize the amount of radio interface bandwidth consumed and therefore significantly improve the PDCH utilization within the telecommunication network. One such optimization is the subject of the present disclosure.

### SUMMARY

A MTC device, a serving node (e.g. SGSN), and various methods for implementing an downlink stack reduction (DSR) feature which reduces the ratio of UDP/IP overhead to MTC data packet payload in MTC communications are described in the independent claims. Advantageous embodiments of the MTC device, the serving node (e.g. SGSN), and the various methods are further described in the dependent claims.

In one aspect, the present disclosure provides a MTC device configured to implement a DSR feature with a serving node (e.g. SGSN). The MTC device comprises a processor, and at least one memory that stores processor-executable instructions, wherein the processor interfaces with the at least one memory to execute the processor-executable instructions, whereby the MTC device is operable to perform a send operation, a first receive operation, an enable operation, a store operation, a second receive operation, and a re-generate operation. In the send operation, the MTC device sends a message to the serving node when activating a PDP context with the serving node, wherein the message comprises an indication which indicates that the MTC device supports the DSR feature. In the receive operation, the MTC device receives a SN-PDU having a payload which comprises UDP/IP layers from the serving node, wherein the SN-PDU is associated with the PDP context with the serving node. In the enable and store operations, the MTC device upon receipt of the SN-PDU enables the DSR feature for the PDP context with the serving node and stores information about the UDP/IP layers within the received SN-PDU. In the second receive operation, the MTC device receives from the serving node a subsequent SN-PDU having an indicator indicating that UDP/IP layers are excluded from a payload therein, wherein the subsequent SN-PDU is associated with the PDP context with the serving node. In the re-generate operation, the MTC device upon receipt of the subsequent SN-PDU, re-generates UDP/IP layers associated with the subsequent SN-PDU using the stored information to create a N-PDU comprising the re-generated UDP/IP layers and the payload of the subsequent SN-PDU. The MTC device by implementing the DSR feature reduces the ratio of UDP/IP overhead to MTC data packet payload in MTC communications which will serve to substantially minimize the amount of radio interface bandwidth consumed and therefore significantly improve the PDCH utilization within the telecommunication network.

In one aspect, the present disclosure provides a method in a MTC device for implementing a DSR feature with a serving node (e.g. SGSN). The method comprises a sending operation, a first receiving operation, an enabling operation, a storing operation, a second receiving operation, and a re-generating operation. In the sending operation, the MTC device sends a message to the serving node when activating a PDP context with the serving node, wherein the message comprises an indication which indicates that the MTC device supports the DSR feature. In the receiving operation, the MTC device receives a SN-PDU having a payload which comprises UDP/IP layers from the serving node, wherein the SN-PDU is associated with the PDP context with the serving node. In the enabling and storing operations, the MTC device upon receipt of the SN-PDU enables the DSR feature for the PDP context with the serving node and stores information about the UDP/IP layers within the received SN-PDU. In the second receiving operation, the MTC device receives from the serving node a subsequent SN-PDU having an indicator indicating that UDP/IP layers are excluded from a payload therein, wherein the subsequent SN-PDU is associated with the PDP context with the serving node. In the re-generating operation, the MTC device upon receipt of the subsequent SN-PDU, re-generates UDP/IP layers associated with the subsequent SN-PDU using the stored information to create a N-PDU comprising the re-generated UDP/IP layers and the payload of the subsequent SN-PDU. The method in the MTC device for implementing the DSR feature reduces the ratio of UDP/IP overhead to MTC data packet payload in MTC communications which will serve to substantially minimize the amount of radio interface bandwidth consumed and therefore significantly improve the PDCH utilization within the telecommunication network.

In yet another aspect, the present disclosure provides a serving node (e.g., SGSN) configured to implement a DSR feature with a MTC device. The serving node comprises at least one processor, and at least one memory that stores processor-executable instructions, wherein the at least one processor interfaces with the at least one memory to execute the processor-executable instructions, whereby the serving node is operable to perform a receive operation, a first send operation, an enable operation, a store operation, and a second send operation. In the receive operation, the serving node receives a message from the MTC device when activating a PDP context with the MTC device, wherein the message comprises an indication which indicates that the MTC device supports the DSR feature. In the first send operation, the serving node sends a SN-PDU having a payload which comprises UDP/IP layers to the MTC device, wherein the SN-PDU is associated with the PDP context with the MTC device. In the enable operation, the serving node enables the DSR feature for the PDP context with the MTC device. In the store operation, the serving node stores status information indicating the DSR feature is enabled for the PDP context with the MTC device. In the second send operation, the serving node sends a subsequent SN-PDU having a payload which excludes UDP/IP layers to the MTC device, wherein the subsequent SN-PDU is associated with the PDP context with the MTC device. The serving node by implementing the DSR feature reduces the ratio of UDP/IP overhead to MTC data packet payload in MTC communications which will serve to substantially minimize the amount of radio interface bandwidth consumed and therefore significantly improve the PDCH utilization within the telecommunication network.

In still yet another aspect, the present disclosure provides a method in a serving node (e.g., SGSN) configured to implement a DSR feature with a MTC device. The method comprises a receiving operation, a first sending operation, an enabling operation, a storing operation, and a second sending operation. In the receiving operation, the serving node receives a message from the MTC device when activating a PDP context with the MTC device, wherein the message comprises an indication which indicates that the MTC device supports the DSR feature. In the first sending operation, the serving node sends a SN-PDU having a payload which comprises UDP/IP layers to the MTC device, wherein the SN-PDU is associated with the PDP context with the MTC device. In the enabling operation, the serving node enables the DSR feature for the PDP context with the MTC device. In the storing operation, the serving node stores status information indicating the DSR feature is enabled for the PDP context with the MTC device. In the second sending operation, the serving node sends a subsequent SN-PDU having a payload which excludes UDP/IP layers to the MTC device, wherein the subsequent SN-PDU is associated with the PDP context with the MTC device. The method in the serving node by implementing the DSR feature reduces the ratio of UDP/IP overhead to MTC data packet payload in MTC communications which will serve to substantially minimize the amount of radio interface bandwidth consumed and therefore significantly improve the PDCH utilization within the telecommunication network.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings:

FIGS. 1A-1B is a diagram illustrating the signaling between a MTC device (e.g., MS), a serving node (e.g. SGSN) and a target serving node (e.g. target SGSN) to implement the DSR feature in accordance with an embodiment of the present disclosure;

FIG. 2 is a flowchart of a method in the MTC device (e.g., MS) for implementing the DSR feature in accordance with an embodiment of the present disclosure;

FIG. 3 is a flowchart of a method in the serving node (e.g. SGSN) for implementing the DSR feature in accordance with an embodiment of the present disclosure;

FIG. 4 is a flowchart of a method in the target serving node (e.g. target SGSN) for implementing the DSR feature in accordance with an embodiment of the present disclosure;

FIG. 5 is a schematic view of the MTC device (e.g., MS), the serving node (e.g. SGSN) and the target serving node (e.g. target SGSN) which are configured to implement the DSR feature and the various methods in accordance with different embodiments of the present disclosure;

FIG. 6 is a diagram of an exemplary Device Properties Information Element within a PDP Context related NAS message which indicates that the MTC device supports the DSR feature and is sent from the MTC device to the serving node (e.g., SGSN) in accordance with an embodiment of the present disclosure;

FIG. 7 is a more detail diagram illustrating the exemplary Device Properties Information Element shown in FIG. 6 in accordance with an embodiment of the present disclosure;

FIG. 8 is a diagram of an UDP header and data field; and,

FIG. 9 is a diagram of an IPv6 header.

### DETAILED DESCRIPTION

The present disclosure describes one possible optimization for reducing the ratio of UDP/IP overhead to MTC data packet payload in MTC communications which will serve to substantially minimize the amount of radio interface bandwidth consumed and therefore significantly improve the PDCH utilization within the wireless telecommunication network. This optimization which is referred to herein as the Downlink Stack Reduction (DSR) feature takes advantage of the high probability that MTC data packets comprising UDP/IP layers will seldom experience changes to the critical fields of these layers when considering the successive MTC data packets which are received by a given MTC device from the same MTC application server located in an IP network. This consistency in the content of the UDP/IP layers allows for using the DSR feature wherein the MTC device retains knowledge of the UDP/IP layers whenever present in the SN-PDU payload corresponding to a given PDP context. This allows the serving node (e.g., SGSN) to exclude UDP/IP layers from the protocol stack of the SN-PDU payload when transmitting subsequent downlink SN-PDUs for that PDP context to the MTC device since the applicable UDP/IP layers will already be known by the MTC device. Although the DSR feature is described herein based on a wireless telecommunication system which utilizes the GSM radio interface it should be appreciated that the DSR feature may be applied in the context of other radio interfaces based on other standards such as, for example, LTE and UMTS

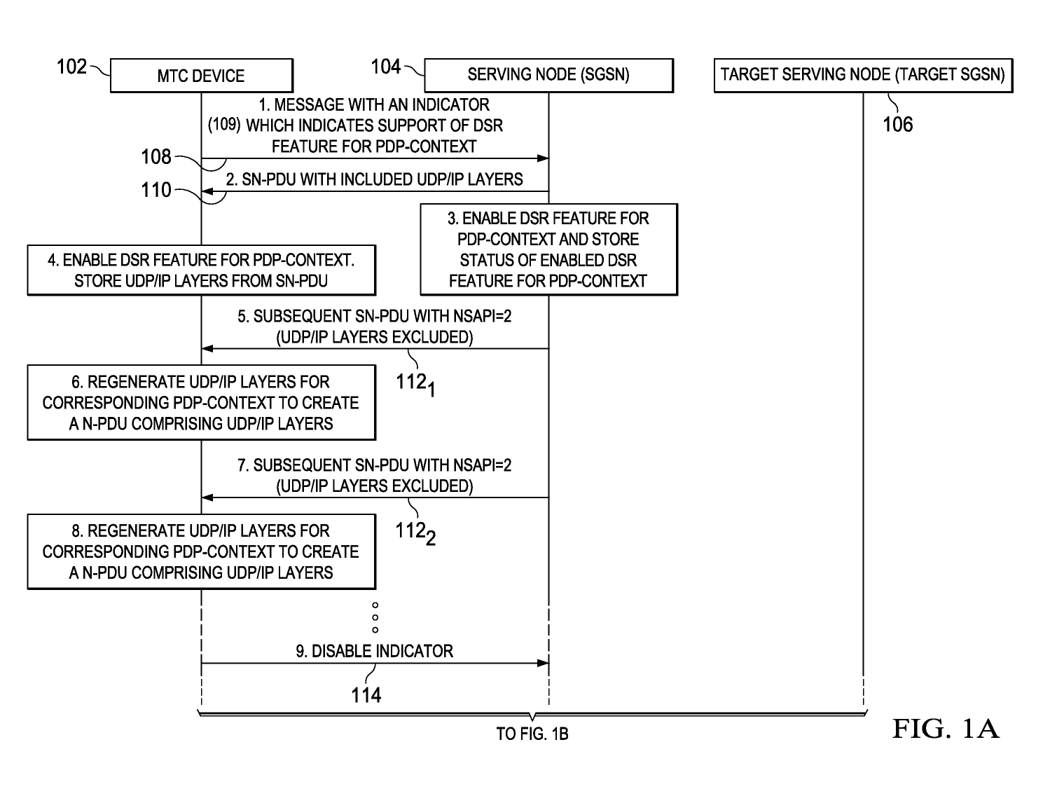

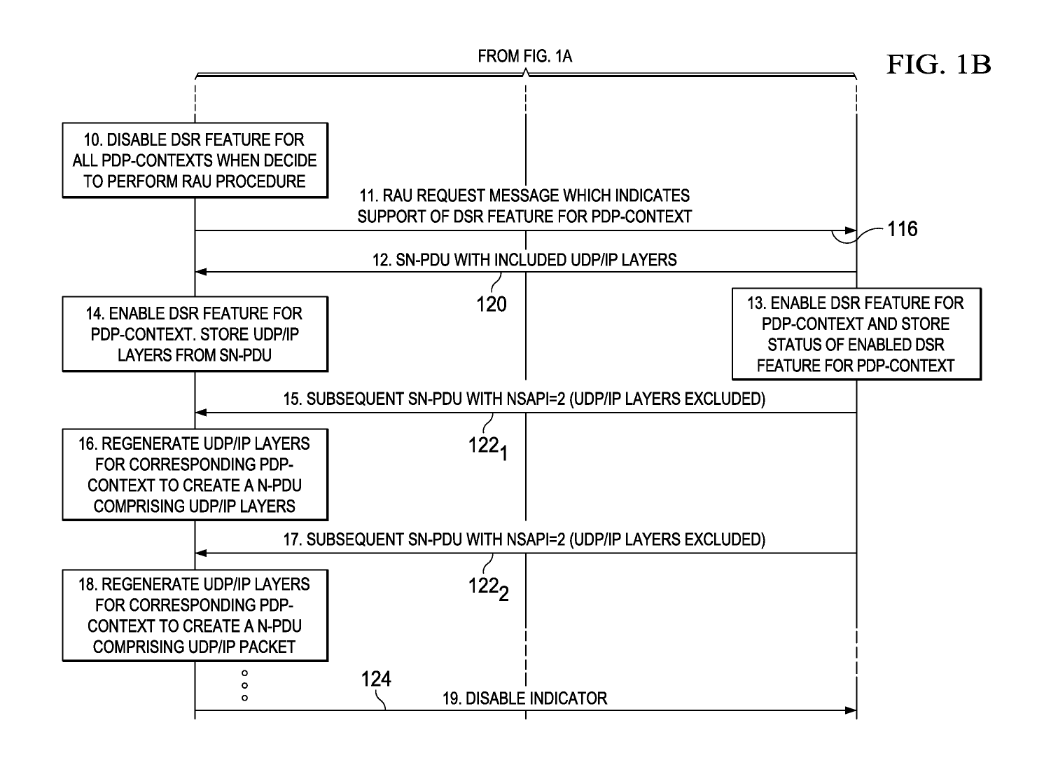

Referring to FIGS. 1A-1B, there is a diagram illustrating the signaling between a MTC device 102 (e.g., MS 102), a serving node 104 (e.g. SGSN 104) and a target serving node 106 (e.g. target SGSN 106) to implement the DSR feature in accordance with an embodiment of the present disclosure. In this exemplary signaling diagram, the three main components namely the MTC device 102 (e.g., MS 102), the serving node 104 (e.g. SGSN 104), and the target serving node 106 (e.g. target SGSN 106) are shown interacting with one another when implementing the new DSR feature as follows:

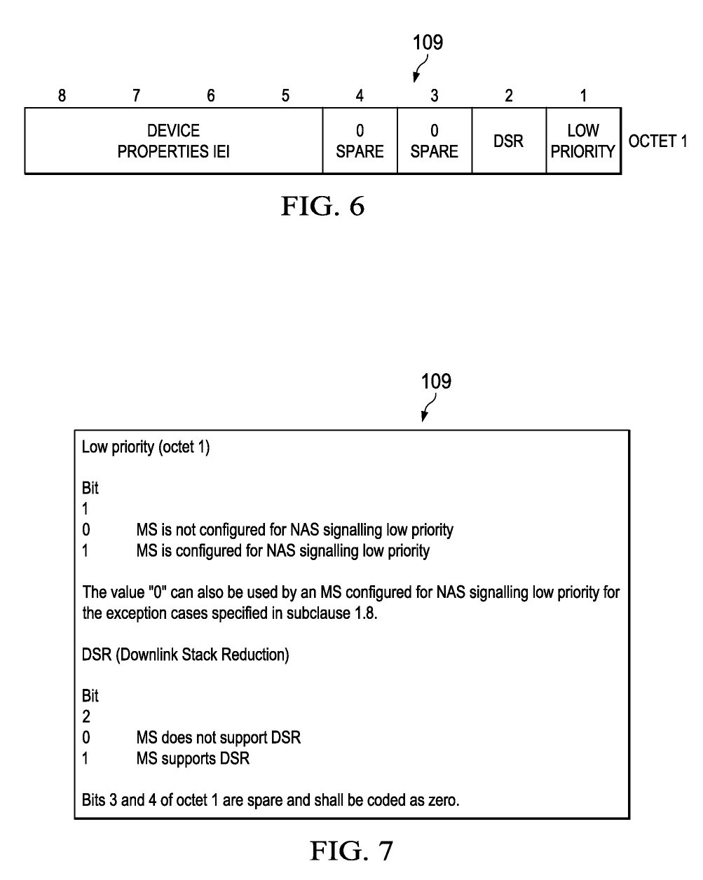

1. The MTC device 102 sends a message 108 to the SGSN 104 when activating a PDP context with the SGSN 104. The message 108 (e.g. NAS message 108—see FIGS. 6-7) comprises an indication 109 which indicates that the MTC device 102 supports the DSR feature. For instance, the message 108 can be a PDP context related NAS message 108 which comprises a device properties information element containing the indication 109 indicating that the MTC device 102 supports the DSR feature (see FIGS. 6-7).

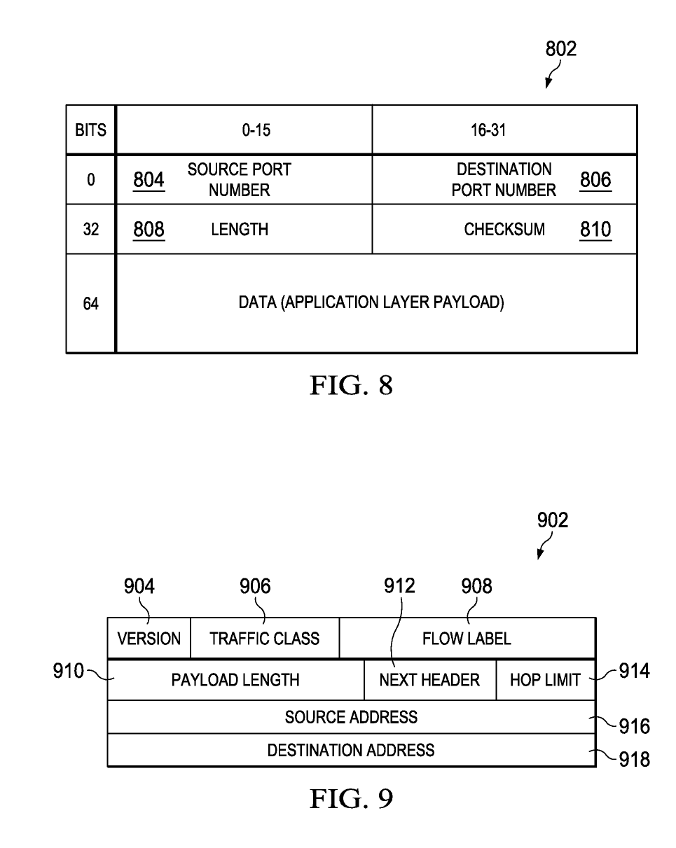

2. At some point the SGSN 104 eventually receives a N-PDU from an IP network and sends a corresponding SN-PDU 110 associated with the PDP context to the MTC device 102. The SN-PDU 110 has a payload which comprises the UDP/IP layers (see FIGS. 8-9).

3. The SGSN 104 enables the DSR feature for the PDP context with the MTC device 102 and stores status information indicating the DSR feature is enabled for the PDP context with the MTC device 102.

4. Upon receiving the SN-PDU 110, the MTC device 102 enables the DSR feature for the PDP context with the SGSN 104 and stores information about the UDP/IP layers within the received SN-PDU 110.

5. The SGSN 104 receives a subsequent N-PDU from the IP network, extracts the UDP/IP layers therefrom and then sends a corresponding subsequent SN-PDU 112₁ associated with the PDP context to the MTC device 102. The subsequent SN-PDU 112₁ has a payload which does not have UDP/IP layers.

6. Upon receiving the subsequent SN-PDU 112₁, the MTC device 102 detects the absence of the UDP/IP layers and therefore re-generates the UDP/IP layers associated with the subsequent SN-PDU 112₁ using the stored information from step 4 to create a N-PDU comprising the re-generated UDP/IP layers and the payload of the SN-PDU 110. Note: the sending of the subsequent SN-PDU 112₁ in step 5 operationally involves a remove step (extract step) where the SGSN 104 as a result of the information saved during the store operation (step 3) removes the UDP/IP layers from a subsequent N-PDU (received from the IP network) before the SGSN 104 inserts the N-PDU's remaining payload into the SN-PDU 112₁. Thereafter, the original N-PDU received from the IP network by the SGSN 104 is what the MTC device 102 creates as a result of the re-generate step 6.

7. The SGSN 104 receives a subsequent N-PDU from an IP network, extracts the UDP/IP layers therefrom and then sends a corresponding subsequent SN-PDU 112₂ associated with the PDP context to the MTC device 102. The subsequent SN-PDU 112₂ has a payload which does not have UDP/IP layers. Note: the SGSN 104 could receive any number of subsequent N-PDUs and can therefore send any number of corresponding subsequent SN-PDUs 112₃, 112₄ . . . 112ₓ which have payloads that do not have UDP/IP layers associated with the PDP context to the MTC device 102.

8. Upon receiving the subsequent SN-PDU 112₂, the MTC device 102 detects the absence of the UDP/IP layers therein and therefore re-generates the UDP/IP layers associated with the subsequent SN-PDU 112₂ using the stored information from step 4 to create a N-PDU comprising the re-generated UDP/IP layers and the payload of the subsequent SN-PDU 112₁. Note 1: the sending of the subsequent SN-PDU 112₂ in step 7 operationally involves a remove step (extract step) where the SGSN 104 as a result of the information saved during the store operation (step 3) removes the UDP/IP layers from a subsequent N-PDU (received from the IP network) before the SGSN 104 inserts the N-PDU's remaining payload into the SN-PDU 112₂. Thereafter, the original N-PDU received from the IP network by the SGSN 104 is what the MTC device 102 creates as a result of the re-generate step 8. Note 2: the MTC device 102 could receive any number of subsequent SN-PDUs 112₃, 112₄ . . . 112ₓ, detect the absence of the UDP/IP layers therein and then re-generate the UDP/IP layers associated with the subsequent SN-PDUs 112₃, 112₄ . . . 112ₓ using the stored information from step 4 to create N-PDUs the re-generated UDP/IP layers and the payloads from the respective subsequent SN-PDUs 112₃, 112₄ . . . 112ₓ.

9. At some point in time, the MTC device 102 can send a disable indicator 114 to the SGSN 104. The disable indicator 114 comprises an indication which indicates that the DSR feature is disabled for the PDP context with the MTC device 102. For example, this point in time can be when the MTC device 102 experiences a failure when attempting to process the application layer payload within a re-generated N-PDU.

The following steps 10-19 describe how the MTC device 102 can initiate a RAU procedure with the target SGSN 106 and implement the DSR feature in accordance with an embodiment of the present disclosure.

10. At some point in time, assume the MTC device 102 decides to perform a RAU procedure with the target SGSN 106 at which this point the MTC device 102 would consider the DSR feature to be disabled for the PDP context with the target SGSN 106. For instance, the MTC device 102 may decide to perform the RAU procedure when it is in idle mode and performs a cell change to a cell in a new routing area associated with the target SGSN 106 in which case the MTC device 102 will not know if the new SGSN 106 supports the DSR feature.

11. The MTC device 102 sends a RAU request message 116 to the target SGSN 106. The RAU request message 116 comprises an indication which indicates that the MTC device 102 supports the DSR feature for the PDP context with the target SGSN 106.

12. After receiving the RAU request message 116, the target SGSN 106 eventually receives a N-PDU from an IP network and sends a corresponding SN-PDU 120 associated with the PDP context to the MTC device 102. The SN-PDU 120 has a payload which comprises the UDP/IP layers (see FIGS. 8-9).

13. The target SGSN 106 enables the DSR feature for the PDP context with the MTC device 102 and stores status information indicating the DSR feature is enabled for the PDP context with the MTC device 102.

14. Upon receiving the SN-PDU 120, the MTC device 102 enables the DSR feature for the PDP context with the target SGSN 106 and stores information about the UDP/IP layers within the received SN-PDU 120.

15. The target SGSN 106 receives a subsequent N-PDU from an IP network, extracts the UDP/IP layers therefrom and then sends a corresponding subsequent SN-PDU 122₁ associated with the PDP context to the MTC device 102. The subsequent SN-PDU 122₁ has a payload which does not have UDP/IP layers.

16. Upon receiving the subsequent SN-PDU 122₁, the MTC device 102 detects the absence of the UDP/IP layers and therefore re-generates the UDP/IP layers associated with the subsequent SN-PDU 122₁ using the stored information from step 14 to create a N-PDU comprising the re-generated UDP/IP layers and the payload of the subsequent SN-PDU 122₁. Note 1: the sending of the subsequent SN-PDU 122₁ in step 15 operationally involves a remove step (extract step) where the target SGSN 106 as a result of the information saved during the store operation (step 13) removes the UDP/IP layers from a subsequent N-PDU (received from the IP network) before the target SGSN 106 inserts the N-PDU's remaining payload into the SN-PDU PDU 122₁. Thereafter, the original N-PDU received from the IP network by the target SGSN 106 is what the MTC device 102 creates as a result of the re-generate step 16.

17. The target SGSN 106 receives a subsequent N-PDU from the IP network, extracts the UDP/IP layers therefrom and then sends a corresponding subsequent SN-PDU 122₂ associated with the PDP context to the MTC device 102. The subsequent SN-PDU 122₂ has a payload which does not have UDP/IP layers. Note: the target SGSN 106 could receive any number of subsequent N-PDUs from an IP network, extract the UDP/IP layers therefrom and therefore send any number of corresponding subsequent SN-PDUs 122₃, 122₄ . . . 122ₓ which have payloads that do not have UDP/IP layers associated with the PDP context to the MTC device 102.

18. Upon receiving the subsequent SN-PDU 122₂, the MTC device 102 detects the absence of the UDP/IP layers therein and therefore re-generates the UDP/IP layers associated with the subsequent SN-PDU 122₂ using the stored information from step 14 to create a N-PDU comprising the re-generated UDP/IP layers and the payload of the subsequent SN-PDU 112₂. Note 1: the sending of the subsequent SN-PDU 122₂ in step 17 operationally involves a remove step (extract step) where the target SGSN 106 as a result of the information saved during the store operation (step 13) removes the UDP/IP layers from a subsequent N-PDU (received from the IP network) before the target SGSN 106 inserts the N-PDU's remaining payload into the SN-PDU 122₂. Thereafter, the original N-PDU received from the IP network by the target SGSN 106 is what the MTC device 102 creates as a result of the re-generate step 18. Note 2: the MTC device 102 could receive any number of subsequent SN-PDUs 122₃, 122₄ . . . 122ₓ, detect the absence of the UDP/IP layers therein and then re-generate the UDP/IP layers associated with the subsequent SN-PDUs 122₃, 122₄ . . . 122ₓ using the stored information from step 14 to create N-PDUs comprising the re-generated UDP/IP layers and the payloads from the respective subsequent SN-PDUs 122₃, 122₄ . . . 122ₓ.

19. At some point in time, the MTC device 102 can send a disable indicator 124 to the target SGSN 106. The disable indicator 124 comprises an indication which indicates that the DSR feature is disabled for the PDP context with the MTC device 102.

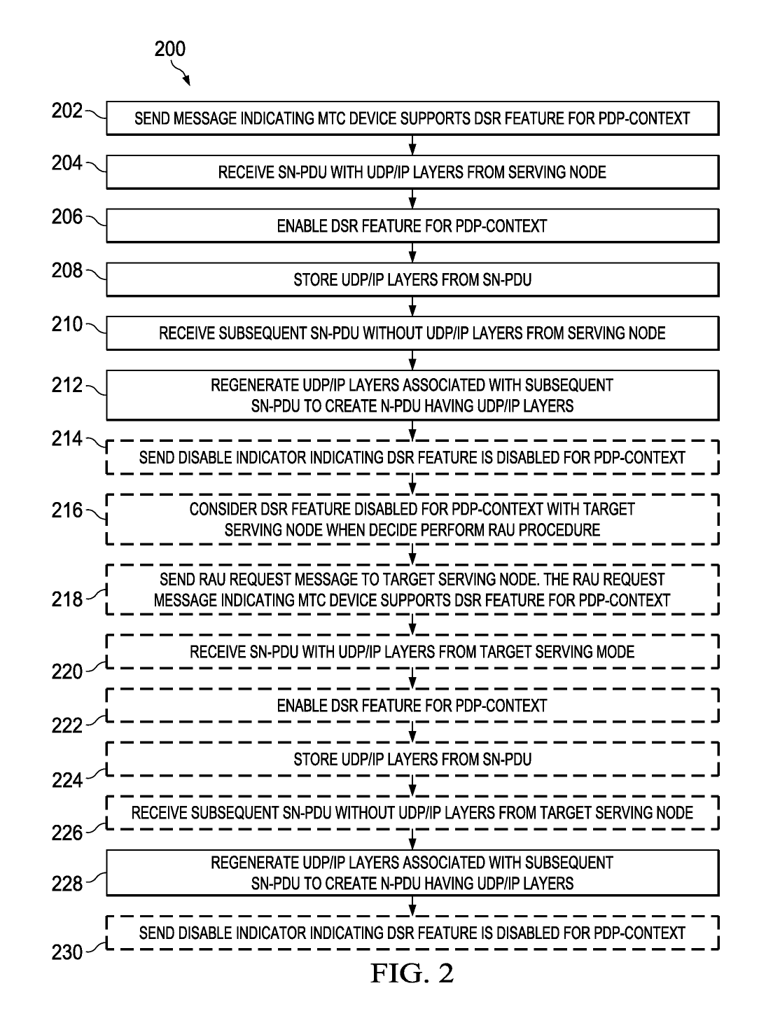

Referring to FIG. 2, there is a flowchart of a method 200 in the MTC device 102 (e.g., MS 102) for implementing the DSR feature in accordance with an embodiment of the present disclosure. At step 202, the MTC device 102 sends the message 108 to the SGSN 104 when activating a PDP context with the SGSN 104, where the message 108 comprises an indication 109 which indicates that the MTC device 102 supports the DSR feature (step 1 of FIGS. 1A-1B). In one example, the message 108 is a PDP context related NAS message 108 which comprises a device properties information element containing the indication 109 indicating that the MTC device 102 supports the DSR feature (see FIGS. 6-7). At step 204, the MTC device 102 receives the SN-PDU 110 having a payload which includes UDP/IP layers from the SGSN 104, where the SN-PDU 110 is associated with the PDP context with the SGSN 104 (step 2 of FIGS. 1A-1B). At step 206, the MTC device 102 enables the DSR feature for the PDP context with the SGSN 104 (step 4 of FIGS. 1A-1B). At step 208, the MTC device 102 stores information about the UDP/IP layers within the received SN-PDU 110 (step 4 of FIGS. 1A-1B). At step 210, the MTC device 102 receives the subsequent SN-PDU 112₁ having a payload which excludes UDP/IP layers from the SGSN 104, where the subsequent SN-PDU 112₁ is associated with the PDP context with the SGSN 104 (step 5 of FIGS. 1A-1B). In one example, the subsequent SN-PDU 112₁ comprises a header with a field (e.g., NSAPI field=2) which indicates that the UDP/IP layers have been excluded therefrom. At step 212, the MTC device 102 upon receipt of the subsequent SN-PDU 112₁ re-generates UDP/IP layers associated with the subsequent SN-PDU 112₁ using the stored information from step 208 to create a N-PDU comprising the re-generated UDP/IP layers and the payload of the subsequent SN-PDU 112₁ (step 6 of FIGS. 1A-1B—note the MTC device 102 can receive multiple subsequent SN-PDUs 112₂, 112₃ . . . 112ₓ and create multiple N-PDUs). At step 214, the MTC device 102 may send the disable indicator 114 to the SGSN 104, where the disable indicator 114 comprises an indication which indicates that the DSR feature is disabled for the PDP context with the SGSN 104 (step 9 of FIGS. 1A-1B).

Prior to step 214, the MTC device 102 while in idle mode may perform a cell re-selection based cell change to a new cell in a new Routing Area supported by the target serving node 106 (e.g., target SGSN 106) in which case it would perform a RAU procedure and implement the DSR feature per steps 216, 218, 220, 222, 224, 226, 228 and 230 described next. At step 216, the MTC device 102 upon deciding to perform a RAU procedure with a target SGSN 106 due to entering a new Routing Area would consider the DSR feature to be disabled for a PDP context with the target SGSN 106 (step 10 of FIGS. 1A-1B). At step 218, the MTC device 102 sends the RAU request message 116 to the target SGSN 106, where the RAU request message 116 contains an indication which indicates that the MTC device 102 supports the DSR feature (step 11 of FIGS. 1A-1B). At step 220, the MTC device 102 receives the SN-PDU 120 having a payload which includes UDP/IP layers from the target SGSN 106, where the SN-PDU 110 is associated with the PDP context with the target SGSN 106 (step 12 of FIGS. 1A-1B). At step 222, the MTC device 102 enables the DSR feature for the PDP context with the target SGSN 106 (step 14 of FIGS. 1A-1B). At step 224, the MTC device 102 stores information about the UDP/IP layers within the received SN-PDU 120 (step 14 of FIGS. 1A-1B). At step 226, the MTC device 102 receives the subsequent SN-PDU 122₁ having a payload which excludes UDP/IP layers from the target SGSN 106, where the subsequent SN-PDU 122₁ is associated with the PDP context with the target SGSN 106 (step 15 of FIGS. 1A-1B). In one example, the subsequent SN-PDU 122₁ comprises a header with a field (e.g., NSAPI field=2) which indicates that the UDP/IP layers have been excluded therefrom. At step 228, the MTC device 102 upon receipt of the subsequent SN-PDU 122₁ re-generates UDP/IP layers associated with the subsequent SN-PDU 122₁ using the stored information from step 224 to create a N-PDU comprising the re-generated UDP/IP layers and the payload of the subsequent SN-PDU 122₁ (step 16 of FIGS. 1A-1B—note the MTC device 102 can receive multiple subsequent SN-PDUs 122₂, 122 ₃ . . . 122ₓ and create multiple N-PDUs). At step 230, the MTC device 102 may send the disable indicator 124 to the target SGSN 106, where the disable indicator 124 comprises an indication which indicates that the DSR feature is disabled for the PDP context with the target SGSN 106 (step 19 of FIGS. 1A-1B).

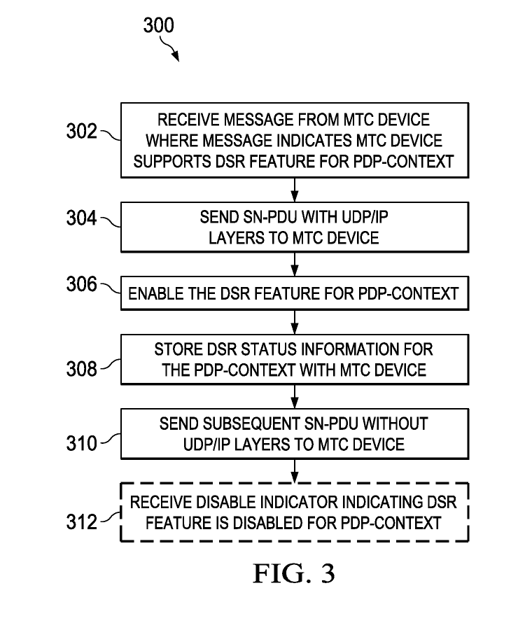

Referring to FIG. 3, there is a flowchart of a method 300 in the serving node 104 (e.g. SGSN 104) for implementing the DSR feature in accordance with an embodiment of the present disclosure. At step 302, the SGSN 104 receives the message 108 from the MTC device 102 when activating a PDP context with the MTC device 102, where the message 108 comprises an indication 109 which indicates that the MTC device 102 supports the DSR feature (step 1 of FIGS. 1A-1B). In one example, the message 108 is a PDP context related NAS message 108 which comprises a device properties information element containing the indication 109 indicating that the MTC device 102 supports the DSR feature (see FIGS. 6-7). At step 304, the SGSN 104 sends the SN-PDU 110 having a payload which includes UDP/IP layers to the MTC device 102, where the SN-PDU 110 is associated with the PDP context with the MTC device 102 (step 2 of FIGS. 1A-1B; note: the SGSN 104 would receive a N-PDU from an IP network and then send the corresponding SN-PDU 110). At step 306, the SGSN 104 enables the DSR feature for the PDP context with the MTC device 102 (step 3 of FIGS. 1A-1B). At step 308, the SGSN 104 stores status information indicating the DSR feature is enabled for the PDP context with the SGSN 104 (step 3 of FIGS. 1A-1B). At step 310, the SGSN 104 sends the subsequent SN-PDU 112₁ having a payload which excludes UDP/IP layers to the MTC device 102, where the subsequent SN-PDU 112₁ is associated with the PDP context with the MTC device 102 (step 5 of FIGS. 1A-1B; note: the SGSN 104 receives a subsequent N-PDU from the IP network, extracts the UDP/IP layers from the received subsequent N-PDU as a result of information saved during step 308, inserts the N-PDU's remaining payload into the SN-PDU 112₁ and sends the SN-PDU 112₁ to the MTC device 102). In one example, the subsequent SN-PDU 112₁ comprises a header with a field (e.g., NSAPI field=2) which indicates that the UDP/IP layers have been excluded therefrom. At step 312, the SGSN 104 may receive the disable indicator 114 from the MTC device 102, where the disable indicator 114 comprises an indication which indicates that the DSR feature is disabled for the PDP context with the MTC device 102 (step 9 of FIGS. 1A-1B).

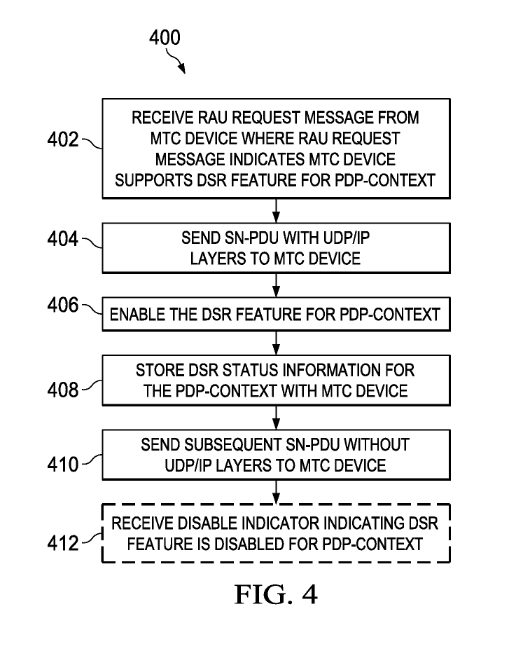

Referring to FIG. 4, there is a flowchart of a method 400 in the target serving node 106 (e.g. target SGSN 106) for implementing the DSR feature in accordance with an embodiment of the present disclosure. At step 402, the target SGSN 106 receives the RAU request message 116 from the MTC device 102 when activating a PDP context with the MTC device 102, where the message 108 comprises an indication 109 which indicates that the MTC device 102 supports the DSR feature (step 11 of FIGS. 1A-1B). At step 404, the target SGSN 106 sends the SN-PDU 120 having a payload which includes UDP/IP layers to the MTC device 102, where the SN-PDU 120 is associated with the PDP context with the MTC device 102 (step 12 of FIGS. 1A-1B; note: the target SGSN 106 would receive a N-PDU from an IP network and then send the corresponding SN-PDU 120). At step 406, the target SGSN 106 enables the DSR feature for the PDP context with the MTC device 102 (step 13 of FIGS. 1A-1B). At step 408, the target SGSN 106 stores status information indicating the DSR feature is enabled for the PDP context with the target SGSN 106 (step 13 of FIGS. 1A-1B). At step 410, the target SGSN 106 sends the subsequent SN-PDU 122₁ having a payload which excludes UDP/IP layers to the MTC device 102, where the subsequent SN-PDU 122₁ is associated with the PDP context with the MTC device 102 (step 15 of FIGS. 1A-1B; note: the target SGSN 106 receives a subsequent N-PDU PDU from the IP network, extracts the UDP/IP layers from the received subsequent N-PDU as a result of information saved during step 408, inserts the N-PDU's remaining payload into the SN-PDU 122₁ and sends the SN-PDU 122₁ to the MTC device 102). In one example, the subsequent SN-PDU 122₁ comprises a header with a field (e.g., NSAPI field=2) which indicates that the UDP/IP layers have been excluded therefrom. At step 412, the target SGSN 106 may receive the disable indicator 124 from the MTC device 102, where the disable indicator 124 comprises an indication which indicates that the DSR feature is disabled for the PDP context with the MTC device 102 (step 19 of FIGS. 1A-1B).

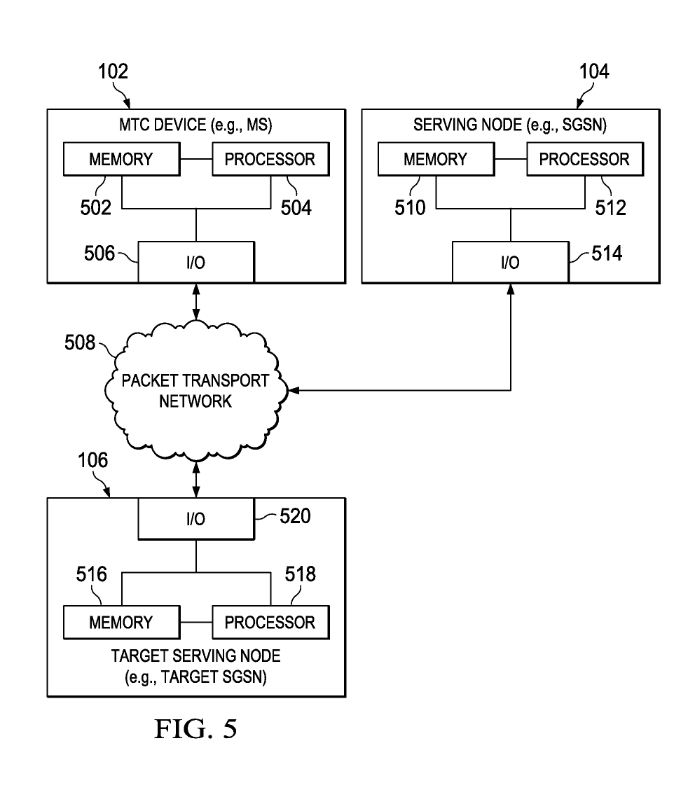

Referring to FIG. 5, there is a schematic view of the MTC device 102 (e.g., MS 102), the serving node 104 (e.g. SGSN 104) and the target serving node 106 (e.g. target SGSN 106) which are configured to implement the DSR feature and the various methods 200, 300 and 400 in accordance with different embodiments of the present disclosure. The MTC device 102 comprises a memory 502, a processor 504 for executing instructions stored in the memory 502 and an input/output device 506 for communication with other nodes and devices such as the SGSN 104 and target SGSN 106 connected to a packet transport network 508. The serving node 104 (e.g. SGSN 104) comprises a memory 510, a processor 512 suitable for executing instructions stored in the memory 510 as well as an input/output device 514 which is also connected to the packet transport network 508. Likewise, the target serving node 106 (e.g. target SGSN 106) comprises a memory 516, a processor 518 suitable for executing instructions stored in the memory 516 as well as an input/output device 520 which is also connected to the packet transport network 508. The present arrangement of the MTC device 102 (e.g., MS 102), the serving node 104 (e.g. SGSN 104) and the target serving node 106 (e.g. target SGSN 106) are suitable for executing the various methods 200, 300 and 400 described herein with respect to FIGS. 1-4.

It should be noted that the MTC device 102 (e.g., MS 102), the serving node 104 (e.g. SGSN 104) and the target serving node 106 (e.g. target SGSN 106) each comprise many other components which are well known in the art but for clarity the well known components are not described herein. Moreover, it should be noted that a typical network would comprise multiple MTC devices 102 and multiple serving nodes 104 and 106 (e.g. SGSN 104 and 106) as well as a plethora of other network nodes which may or may not be in the path of packets sent between the MTC device 102 and the serving nodes 104 and 106 (e.g. SGSN 104 and 106). As one example, a Radio Base Station, not depicted, is in radio connection with the MTC device 102, receiving packets from the MTC device 102 and forwarding them possibly through other network node(s) to one of the serving nodes 104 and 106 (e.g. SGSNs 104 and 106).

Further, it should be noted that there are many different types of memories 502, 510 and 516 available, such as solid states drives, hard drives, RAM, ROM, EPROM, EEPROM etc. which could be used in implementing embodiments disclosed herein. The memory 502 used for the MTC device 102 would typically be different from the memories 510 and 516 used for the serving nodes 104 and 106 (e.g. SGSNs 104 and 106), however there is absolutely nothing preventing them for utilizing the same kind of memory. Also, while not indicated in the schematic view, there might be multiple different memories in the devices disclosed. Typically, there would be persistent storage as well as Random Access Memory. Also the processors 504, 512 and 518 indicated in the schematic view can be implemented in many different forms, such as an off-the-shelf microcontroller, an ASIC, FPGA etc.

The following is a more detailed discussion of the DSR feature with respect to the following aspects: (1) Static UDP/IP Header Information; (2) Managing a DSR profile; (3) Re-Generating the UDP/IP layers; and (4) Changes to Standards to Implement DSR feature.

### (1) Static UDP/IP Header Information

The PDP Context activation procedure can be used to inform the SGSN 104 when the MTC device 102 supports the DSR feature for a given PDP Context. The SGSN 104 that supports DSR will then realize that after sending a downlink SN-PDU 110 to such a MTC device 102 wherein the UDP/IP layers were included in the SN-PDU 110's PDU payload, that it can exclude the UDP/IP layers in all subsequent SN-PDUs 112₁, 112₂ . . . 112ₓ sent to that MTC device 102 for that PDP Context.
This is possible since UDP/IP headers will essentially be static as the same MTC application server located in an IP network will be sending MTC data packets to the same MTC device 102 for as long as the corresponding PDP Context remains activated (i.e., only the content of the Data field and Length field in the UDP/IP headers will change when considering successive MTC data packets sent to the same MTC device 102—see FIGS. 8-9).
By keeping the UDP/IP layers present within the first downlink SN-PDU 110 sent after PDP Context activation, allows the MTC device 102 a convenient way of determining the static content of the UDP/IP layers in the subsequent SN-PDUs 112₁, 112₂ . . . 112ₓ. For example, the UDP source port number applicable to the MTC application server will not be known at the point of completing the PDP Context activation procedure and so the MTC device 102 must receive at least one SN-PDU 110 wherein the SN-PDU payload includes the UDP/IP layers.

### (2) Managing a DSR Profile

The MTC device 102 (e.g., MS 102) indicates it supports DSR on a PDP Context basis by including the Device Properties IE 109 within the PDP Context related NAS message 108 which can be modified to be shown in FIGS. 6-7.

Upon receiving the PDP Context related NAS message 108 with such an indication 109, the SGSN 104 that supports DSR can enable it after sending the corresponding MTC device 102 (e.g., MS 102) at least one SN-PDU 110 for that PDP Context wherein the UDP/IP layers are included in the SN-PDU payload.
Upon enabling DSR for a given PDP Context, the SGSN 104 retains knowledge of the enabled status for as long as it retains that PDP Context.
The MTC device 102 enables DSR for that PDP Context upon receiving the SN-PDU 110 wherein the UDP/IP layers are included in the SN-PDU payload.
Upon enabling DSR for a given PDP Context, the MTC device 102 retains knowledge of the corresponding UDP/IP layers for as long as it retains that PDP.
When sending the subsequent SN-PDUs 112₁, 112₂ . . . 112ₓ, the SGSN 104 sets NSAPI=2 in the header to indicate the UDP/IP layers have been excluded (i.e., the N-PDU consists of a MTC data packet). This allows the MTC device 102 (e.g., MS 102) to re-generate the UDP/IP layers for the subsequent SN-PDUs 112₁, 112₂ . . . 112ₓ associated with the corresponding PDP Context and thereby determine how to further process the N-PDUs.
The MTC device 102 (e.g., MS 102) can disable DSR by sending the SGSN 104 a PDP context related NAS message 114 (e.g., GPRS Session management Message 114) where the Device Properties IE is included and indicates DSR is not supported.
Upon deciding to perform a Routing Area Update (RAU) due to entering a new Routing Area, the MTC device 102 would consider DSR to be disabled (for all PDP Contexts) since the RAU may result in establishing a new SGSN 106 which does not support the DSR feature.
Upon receiving a RAU Request message 116 indicating the DSR feature is supported, the target SGSN 106 enables DSR for a given PDP Context by sending the MTC device 102 at least one SN-PDU 120 for that PDP Context wherein the UDP/IP layers are included in the SN-PDU payload.

### (3) Regenerating the UDP/IP Layers

For the case where the DSR feature is enabled for a given PDP Context, the SGSN 104 includes the UDP/IP layers present within at least the first downlink SN-PDU 110 sent after PDP Context activation/modification. The SGSN 104 can then omit the UDP/IP layers when sending subsequent SN-PDUs 112₁, 112₂ . . . 112ₓ corresponding to that PDP Context to the MTC device 102.

An indication of when the DSR feature has been applied by the SGSN 104 can be provided in the subsequent SN-PDUs 112₁, 112₂ . . . 112ₓ with the SNDCP header by using a currently unused value for the NSAPI field (e.g., NSAPI=2 is available).

Receiving this indication in the SNDCP header (i.e., NSAPI=2) indicates to the MTC device 102 that the next layer in the protocol stack is the MTC application layer (i.e., the N-PDU consists of a MTC data packet) at which point the MTC device 102 can logically re-create the UDP/IP layers for the corresponding PDP Context and thereby create a new N-PDU having a UDP/IP packet (carrying the MTC data packet as the UDP layer payload) which can then be further processed.

Note: that the size of a SN-PDU is determined by the size of the information field of a LLC-PDU consisting of a LLC UI frame. N201-U determines the maximum size of this information field (see 3GPP TS 44.064 V11.0.0—the contents of which are incorporated herein by reference) and may be as large as 1520 octets as established using legacy XID Exchange negotiation (default=500 octets for LLC SAPI=3, 5, 9 11). As such, a SN-PDU containing a N-PDU consisting of a MTC data packet (e.g., 100 octets) is typically expected to be mapped into a single LLC PDU. The XID Exchange (XID) is typically done shortly after completion of the PDP Context activated for use by the MTC device 102 but may be done at any time prior to using the corresponding PDP Context. It is also expected PCOMP=0 will be indicated for SNDCP operation as a result of the XID procedure (i.e., no header compression or data compression is used when sending a N-PDU containing a MTC data packet due to the minimal compression gains that can be expected for small data transmissions). As such, the DSR feature described herein can effectively be used to logically realize UDP/IP header compression without the MTC device 102 and the SGSN 104 or 106 having to implement header compression at the SNDCP layer of the protocol stack.

(4) Changes to Standards to Implement DSR feature

3GPP TS 24.008 V12.4.0 (the contents of which are incorporated herein by reference) specifies the procedures used at the radio interface core network within the 3rd generation mobile telecommunications system and the digital cellular telecommunications system. The following additions to the 3GPP TS 24.008 are necessary to implement at least some embodiments disclosed herein. It should also be noted that while the present embodiments are described in the context of GSM it may also be applied in the context of other radio interfaces, for example LTE and UMTS.
Modify a spare bit within the Device Properties IE to allow an MS (e.g., MTC device) to send an Activate PDP Context Request, Modify PDP Context Request and Activate Secondary PDP Context Request message that indicates it supports the DSR feature for the indicated PDP Context.
Introduce new SGSN functionality whereby reception of such a PDP Context related NAS message results in the SGSN retaining knowledge of the DSR feature status for the corresponding PDP Context for as long as it retains that PDP Context.
Modify the content of a Routing Area Update Request message to include an indication of whether or not a MS (e.g., MTC device) supports DSR.

3GPP TS 44.065 V11.0.0 “Mobile Station (MS)—Serving GPRS Support Node (SGSN); Subnetwork Dependent Convergence Protocol (SNDCP)” (the contents of which are incorporated herein by reference) provides the description of the Subnetwork Dependent Convergence Protocol (SNDCP) for the General Packet Radio Service (GPRS). The modification to this specification would include allowing the NSAPI field in the header of a SN-PDU to be set to a currently unused value (e.g., NSAPI=2) to indicate an uplink SN-PDU sent by the SGSN is making use of the DSR feature (e.g., NSAPI=2 indicates the UDP/IP layers are not included in the SN-PDU payload but need to be regenerated).

The following additions to the 3GPP TS 24.008 V12.4.0 (the contents of which are incorporated herein by reference) are necessary for at least some embodiments disclosed herein. It should also be noted that while the present embodiments are described in the context of GSM it may also be applied in the context of other radio interfaces, for example LTE and UMTS.
Allocate a reserved NSAPI value (e.g. NSAPI=2) which is used to indicate a downlink SN-PDU sent by the SGSN makes use of the DSR feature (i.e., NSAPI=2 indicates the UDP/IP layers are not included in the SN-PDU payload but need to be regenerated).
Introduce new MS (e.g., MTC device) functionality where upon reception of a SN-PDU corresponding to a PDP Context for which it has indicated it supports DSR will retain knowledge of the UDP/IP layers included that SN-PDU payload (i.e., in this case NSAPI will not be set to 2).
Introduce new MS (e.g., MTC device) functionality to support the reception of NSAPI=2 in the header of an SN-PDU by re-generating the UDP/IP layers for the corresponding PDP Context and processing the N-PDU according to the re-generated UDP/IP layers.
   The following is a brief discussion about UDP layers (FIG. 8—UDP Header+Data Field) and IP layers (FIG. 9—IPv6 header) where if desired more details about the UDP and IP layers can be found in the following specifications: RFC 768 and RFC 760 (the contents of which are incorporated herein by reference).

### UDP Packet Format

UDP is a minimal message-oriented Transport Layer protocol that is documented in IETF RFC 768. UDP provides no guarantees to the upper layer protocol for message delivery and the UDP protocol layer retains no state of UDP messages once sent. For this reason, UDP is sometimes referred to as “Unreliable Datagram Protocol”. UDP provides application multiplexing (via port numbers) and integrity verification (via checksum) of the header and payload (see FIG. 8). If transmission reliability is desired, it must be implemented in the user's application or at a lower layer in the protocol stack. As shown in FIG. 8, the UDP header 802 consists of four fields 804, 806, 808 and 810 each of which is 2 bytes (16 bits). The use of two of these fields namely the Source Port Number field 804 and Checksum field 810 is optional in IPv4. In IPv6 only the source port number field 804 is optional. These fields 804, 806, 808 and 810 are discussed in more detail below:

Source Port Number field 804: This field 804 identifies the sender's port when meaningful and should be assumed to be the port to reply to if needed. If it is not used, then it should be zero. If the source host is the client, then the port number is likely to be an ephemeral port number. If the source host is the server, then the port number is likely to be a well-known port number. This field 804 is expected to be static based on the assumptions provided above and is optional for IPv6.

Destination Port Number field 806: This field 806 identifies the receiver's port and is required. Similar to source port number, if the client is the destination host then the port number will likely be an ephemeral port number and if the destination host is the server then the port number will likely be a well-known port number. This field 806 is expected to be static based on the assumptions provided above.

Length field 808: This field 808 specifies the length in bytes of the entire UDP datagram: header and data. The minimum length is 8 bytes since that is the length of the header. The field size sets a theoretical limit of 65,535 bytes (8 byte header+65,527 bytes of data) for a UDP datagram. The practical limit for the data length which is imposed by the underlying IPv4 protocol is 65,507 bytes (65,535−8 byte UDP header−20 byte IP header). This field 808 will vary as the length of the application payload varies.

Checksum field 810: This field 810 is used for error-checking of the header and data. If no checksum is generated by the transmitter, then the field uses the value all-zeros. This field 810 is not optional for IPv6. The field 810 could either be made static (i.e., set to all-zeros) or set according header and data content. The field 810 can be set to all-zeros for the case of GSM since the LLC PDUs sent from a UE (e.g., MS, MTC device) to the SGSN already support a checksum field (i.e. the integrity of the application layer payload sent by the MS will be ensured using legacy LLC operation via CRC-24).

### IPv6 Packet Format

An Internet Protocol version 6 (IPv6) data packet comprises of two main parts, the header and the payload. The first 40 bytes/octets (40×8=320 bits) of an IPv6 packet comprise the IPv6 header 902 (FIG. 9—note: the present disclosure is not limited to the IPv6 header but could also be implemented with an IPv4 header). As shown in FIG. 9, the IPv6 header 902 contains the following fields:

Version field 904: This 4-bit field 904 contains the number “6”. It indicates the version of the IPv6 protocol. This field 904 is the same size as the IPv4 version field that contains the number “4”. However, this field 904 has a limited use because IPv4 and IPv6 packets are not distinguished based on the value in the version field but by the protocol type present in the layer 2 envelope. This field 904 will be static for very long periods of time.

Traffic Class field 906: This 8-bit field 906 can assume different values to enable the source node to differentiate between the packets generated by it by associating different delivery priorities to them. This field 906 is subsequently used by the originating node and the routers to identify the data packets that belong to the same traffic class and distinguish between packets with different priorities. This field 906 is expected to be static based on the assumptions provided above.

Flow Label field 908: This 20-bit field 908 can be used by a source to label a set of packets belonging to the same flow. A flow is uniquely identified by the combination of the source address and of a non-zero flow label. Multiple active flows may exist from a source to a destination as well as traffic that are not associated with any flow (flow label=0). This field 908 is expected to be set to “0” based on the assumptions provided above.

Payload Length field 910: This 16-bit field 910 contains the length of the data field in octets/bits following the IPv6 packet header (i.e. this will reflect the UDP header length+the application layer payload length). The 16-bit Payload length field 910 puts an upper limit on the maximum packet payload to 64 kilobytes. In case a higher packet payload is required, a jumbo payload extension header is provided in the IPv6 protocol. A jumbo payload (jumbogram) is indicated by the value zero in the Payload Length field 910. Jumbograms are frequently used in supercomputer communications using the IPv6 protocol to transmit heavy data payload. This field 910 will vary as the length of the application payload varies.

Next Header field 912: This 8-bit field 912 identifies the type of header immediately following the IPv6 header and located at the beginning of the data field (payload) of the IPv6 packet. This field 912 usually specifies the transport layer protocol used by a packet's payload. The two most common kinds of Next Headers are TCP and UDP, but many other headers are also possible. The format adopted for this field 912 is the one proposed for IPv4 by RFC 1700 (the contents of which are hereby incorporated herein by reference). In case of IPv6 protocol, the Next Header field 912 is similar to the IPv4 Protocol field. This field 912 is expected to be static (i.e., set to indicate UDP) based on the assumptions provided above.

Hop Limit field 914: This 8-bit field 914 is decremented by one, by each node (typically a router) that forwards a packet. If the Hop Limit field 914 is decremented to zero, the packet is discarded. The main function of this field 914 is to identify and to discard packets that are stuck in an indefinite loop due to any routing information errors. The 8-bit field 914 also puts an upper limit on the maximum number of links between two IPv6 nodes. In this way, an IPv6 data packet is allowed a maximum of 255 hops before it is eventually discarded. An IPv6 data packet can pass through a maximum of 254 routers before being discarded. This field 914 is expected to be static based on the assumptions provided above.

Source Address field 916 and Destination Address field 918: For IPv6 these fields 916 and 918 are each 16-octets.

In view of the foregoing, the present disclosure describes an example where the MTC device 102 indicates DSR support for a PDP context in an NAS message 108 sent to the SGSN 104. The SGSN 104 enables DSR and sends a first SN-PDP message 110 including UDP/P layers to the MTC device 102. The MTC device 102 enables DSR for the PDP-context and stores necessary information for the PDP-context. The subsequent SN-PDP messages 112₁, 112₂ . . . 112ₓ from the SGSN 104 for that PDP-context comprises and indication, e.g. NSAPI=2, that the UDP/IP layers are excluded. Upon receiving such SN-PDP messages 112₁, 112₂ . . . 112ₓ, the MTC device 102 re-generates the UDP/IP layers for the PDP-context using the stored information. Using the NSAPI=2 indicator is but one example of indicators available for indication the use of DSR from the SGSN 104 to the MTC device 102. The optimization associated with the DSR feature where the SGSN 104 eliminates the repeated inclusion of UDP/IP protocol overhead (46 or 48 octets) for such MTC data packets sent over the radio interface is beneficial due to the fact that MTC devices 102 are expected to commonly transmit small MTC data packets (e.g. 100 octets or less) for a high percentage of MTC transmissions. Thus, given that the volume of small MTC data packets is expected to increase dramatically as MTC devices 102 become rapidly deployed in the near future, the radio interface bandwidth savings that can be realized using embodiments of the DSR feature disclosed herein is expected to significantly improve the PS domain traffic capacity (PDCH utilization) of any wireless network supporting the MTC use case as well as contribute to MTC device power savings in that few radio blocks will need to be received.

Although multiple embodiments of the present disclosure have been illustrated in the accompanying Drawings and described in the foregoing Detailed Description, it should be understood that the invention is not limited to the disclosed embodiments, but instead is also capable of numerous rearrangements, modifications and substitutions without departing from the present disclosure that as has been set forth and defined within the following claims.

1. A machine type communications (MTC) device configured to implement a downlink stack reduction (DSR) feature with a serving node, the MTC device comprising:
a processor; and,
at least one memory that stores processor-executable instructions, wherein the at least one processor interfaces with the at least one memory to execute the processor-executable instructions, whereby said MTC device is operable to:
send a message to the serving node when activating a Packet Data Protocol (PDP) context with the serving node, wherein the message comprises an indication which indicates that the MTC device supports the DSR feature;
receive, from the serving node, a Sub Network Protocol Data Unit (SN-PDU) having a payload comprising User Datagram Protocol/Internet Protocol (UDP/IP) layers, wherein the SN-PDU is associated with the PDP context with the serving node;
upon receipt of the SN-PDU, enable the DSR feature for the PDP context with the serving node and store information about the UDP/IP layers from the received SN-PDU;
receive, from the serving node, a subsequent SN-PDU having an indicator indicating that UDP/IP layers are excluded from a payload therein, wherein the subsequent SN-PDU is associated with the PDP context with the serving node; and,
upon receipt of the subsequent SN-PDU, re-generate UDP/IP layers associated with the subsequent SN-PDU using the stored information to create a Network-Packet Data Unit (N-PDU) comprising the re-generated UDP/IP layers and the payload of the subsequent SN-PDU.

2. The MTC device of claim 1, wherein the MTC device is further operable to:
send a disable indicator to the serving node, wherein the disable indicator comprises an indication which indicates that the DSR feature is disabled for the PDP context with the serving node.

3. The MTC device of claim 1, wherein the message is a PDP context related Non-Access Stratum (NAS) message comprising a Device Properties information element which contains the indication which indicates that the MTC device supports the DSR feature.

4. The MTC device of claim 1, wherein the subsequent SN-PDU further comprises a header with a field which indicates that the UDP/IP layers have been excluded therefrom.

5. The MTC device of claim 4, wherein the field is a Network Service Access Point Identifier (NSAPI) field set to a specific value which indicates that the UDP/IP layers have been excluded therefrom.

6. The MTC device of claim 1, wherein the MTC device after changing from a cell of the serving node to a new cell of the target serving node is further operable to implement the DSR feature with the target serving node as follows:
upon deciding to perform a Routing Area Update (RAU) procedure with the target serving node due to the new cell of the target serving node belonging to a Routing Area which is different from that of the cell of the serving node, consider the DSR feature to be disabled for a PDP context with the target serving node;
send a RAU request message to the target serving node, wherein the RAU request message comprises an indication which indicates that the MTC device supports the DSR feature;
receive, from the target serving node, a SN-PDU having a payload comprising UDP/IP layers, wherein the SN-PDU is associated with the PDP context with the target serving node;
upon receipt of the SN-PDU from the target serving node, enable the DSR feature for the PDP context with the target serving node and store information about the UDP/IP layers from the received SN-PDU;
receive, from the target serving node, a subsequent SN-PDU having an indicator indicating that UDP/IP layers are excluded from a payload therein, wherein the subsequent SN-PDU is associated with the PDP context with the target serving node; and,
upon receipt of the subsequent SN-PDU from the target serving node, re-generate the UDP/IP layers associated with the subsequent SN-PDU using the stored information to create a Network-Packet Data Unit (N-PDU) comprising the re-generated UDP/IP layers and the payload of the subsequent SN-PDU.

7. The MTC device of claim 1, wherein the MTC device is a mobile station and the serving node is a Service GPRS Support Node (SGSN).

8. A method in a machine type communications (MTC) device for implementing a downlink stack reduction (DSR) feature with a serving node, the method comprising:
sending a message to the serving node when activating a Packet Data Protocol (PDP) context with the serving node, wherein the message comprises an indication which indicates that the MTC device supports the DSR feature;
receiving, from the serving node, a Sub Network Protocol Data Unit (SN-PDU) having a payload comprising User Datagram Protocol/Internet Protocol (UDP/IP) layers, wherein the SN-PDU is associated with the PDP context with the serving node;
upon receipt of the SN-PDU, enabling the DSR feature for the PDP context with the serving node and storing information about the UDP/IP layers from the received SN-PDU;
receiving, from the serving node, a subsequent SN-PDU having an indicator indicating that UDP/IP layers are excluded from a payload therein, wherein the subsequent SN-PDU is associated with the PDP context with the serving node; and,
upon receipt of the subsequent SN-PDU, re-generating UDP/IP layers associated with the subsequent SN-PDU using the stored information to create a Network-Packet Data Unit (N-PDU) comprising the re-generated UDP/IP layers and the payload of the subsequent SN-PDU.

9. The method of claim 8, further comprising:
sending a disable indicator to the serving node, wherein the disable indicator comprises an indication which indicates that the DSR feature is disabled for the PDP context with the serving node.

10. The method of claim 8, wherein the message is a PDP context related Non-Access Stratum (NAS) message comprising a Device Properties information element which contains the indication which indicates that the MTC device supports the DSR feature.

11. The method of claim 8, wherein the subsequent SN-PDU further comprises a header with a field which indicates that the UDP/IP layers have been excluded therefrom.

12. The method of claim 11, wherein the field is a Network Service Access Point Identifier (NSAPI) field set to a specific value which indicates that the UDP/IP layers have been excluded therefrom.

13. The method of claim 8, wherein the MTC device after changing from a cell of the serving node to a new cell of the target serving node is further operable to implement the DSR feature with the target serving node as follows:
upon deciding to perform a Routing Area Update (RAU) procedure with the target serving node due to the new cell of the target serving node belonging to a Routing Area which is different from that of the cell of the serving node, considering the DSR feature to be disabled for a PDP context with the target serving node;
sending a RAU request message to the target serving node, wherein the RAU request message comprises an indication which indicates that the MTC device supports the DSR feature;
receiving, from the target serving node, a SN-PDU having a payload comprising UDP/IP layers, wherein the SN-PDU is associated with the PDP context with the target serving node;
upon receipt of the SN-PDU from the target serving node, enabling the DSR feature for the PDP context with the target serving node and storing information about the UDP/IP layers from the received SN-PDU;
receiving, from the target serving node, a subsequent SN-PDU having an indicator indicating that UDP/IP layers are excluded from a payload therein, wherein the subsequent SN-PDU is associated with the PDP context with the target serving node; and,
upon receipt of the subsequent SN-PDU from the target serving node, re-generating the UDP/IP layers associated with the subsequent SN-PDU using the stored information to create a Network-Packet Data Unit (N-PDU) comprising the re-generated UDP/IP layers and the payload of the subsequent SN-PDU.

14. The method of claim 8, wherein the MTC device is a mobile station and the serving node is a Service GPRS Support Node (SGSN).

15. A serving node configured to implement a downlink stack reduction (DSR) feature with a machine type communications (MTC) device, the serving node comprising:
a processor; and,
at least one memory that stores processor-executable instructions, wherein the at least one processor interfaces with the at least one memory to execute the processor-executable instructions, whereby said serving node is operable to:
receive a message from the MTC device when activating a Packet Data Protocol (PDP) context with the MTC device, wherein the message comprises an indication which indicates that the MTC device supports the DSR feature;
send, to the MTC device, a Sub Network Protocol Data Unit (SN-PDU) having a payload comprising User Datagram Protocol/Internet Protocol (UDP/IP) layers, wherein the SN-PDU is associated with the PDP context with the MTC device;
enable the DSR feature for the PDP context with the MTC device;
store information indicating the DSR feature is enabled for the PDP context with the MTC device; and,
send, to the MTC device, a subsequent SN-PDU having a payload which excludes UDP/IP layers, wherein the subsequent SN-PDU is associated with the PDP context with the MTC device.

16. The serving node of claim 15, wherein the serving node is further operable to:
receive a disable indicator from the MTC device, wherein the disable indicator comprises an indication which indicates that the DSR feature is disabled for the PDP context with the MTC device.

17. The serving node of claim 15, wherein the subsequent SN-PDU further comprises a header with a field which indicates that the UDP/IP layers have been excluded therefrom.

18. The serving node of claim 17, wherein the field is a Network Service Access Point Identifier (NSAPI) field set to a specific value which indicates that the UDP/IP layers have been excluded therefrom.

19. The serving node of claim 15, wherein the message is one of:
a PDP context related Non-Access Stratum (NAS) message comprising a Device Properties information element which contains the indication which indicates that the MTC device supports the DSR feature; or
a Routing Area Update (RAU) request message.

20. The serving node of claim 15, wherein the MTC device is a mobile station and the serving node is a Service GPRS Support Node (SGSN).

21. A method in a serving node for implementing a downlink stack reduction (DSR) feature with a machine type communications (MTC) device, the method comprising:
receiving a message from the MTC device when activating a Packet Data Protocol (PDP) context with the MTC device, wherein the message comprises an indication which indicates that the MTC device supports the DSR feature;
sending, to the MTC device, a Sub Network Protocol Data Unit (SN-PDU) having a payload comprising User Datagram Protocol/Internet Protocol (UDP/IP) layers, wherein the SN-PDU is associated with the PDP context with the MTC device;
enabling the DSR feature for the PDP context with the MTC device;
storing information indicating the DSR feature is enabled for the PDP context with the MTC device; and,
sending, to the MTC device, a subsequent SN-PDU having a payload which excludes UDP/IP layers, wherein the subsequent SN-PDU is associated with the PDP context with the MTC device.

22. The method of claim 21, further comprising:
receiving a disable indicator from the MTC device, wherein the disable indicator comprises an indication which indicates that the DSR feature is disabled for the PDP context with the MTC device.

23. The method of claim 21, wherein the subsequent SN-PDU further comprises a header with a field which indicates that the UDP/IP layers have been excluded therefrom.

24. The method of claim 23, wherein the field is a Network Service Access Point Identifier (NSAPI) field set to a specific value which indicates that the UDP/IP layers have been excluded therefrom.

25. The method of claim 21, wherein the message is one of:
a PDP context related Non-Access Stratum (NAS) message comprising a Device Properties information element which contains the indication which indicates that the MTC device supports the DSR feature; or
a Routing Area Update (RAU) request message.

26. The method of claim 21, wherein the MTC device is a mobile station and the serving node is a Service GPRS Support Node (SGSN).
